(19) United States
(12) Patent Application Publication
(10) Pub. No.: US 2015/0151379 A1
(43) Pub. Date: Jun. 4, 2015

(54) Method for producing a composite component

(71) Applicants: Markus Zömack, Dortmund (DE); Oliver Vogt, Dortmund (DE)

(72) Inventors: Markus Zömack, Dortmund (DE); Oliver Vogt, Dortmund (DE)

(73) Assignee: THYSSENKRUPP STEEL EUROPE AG, Duisburg (DE)

(21) Appl. No.: 14/556,482

(22) Filed: Dec. 1, 2014

(30) Foreign Application Priority Data
Dec. 2, 2013 (DE) 102013224685.4

(51) Int. Cl. B23K 20/12; B23K 20/00; B32B 15/01

(52) U.S. Cl. CPC B23K 20/122; B32B 15/01; B23K 20/002

(57) ABSTRACT

A method for producing a composite component for a vehicle is proposed, wherein, in a first method step, a formed first component is provided, wherein, in a second method step, a formed second component is provided, and wherein, in a third method step, the first component and the second component are connected to one another, wherein furthermore, in the third method step, the first component and the second component are connected to one another by friction stir welding, wherein, in the first method step, a first component of a first specification is provided, and wherein, in the second method step, a second component of a second specification that differs from the first specification is provided.

### FIELD

The present disclosure relates to a method for producing a composite component.

### BACKGROUND

In the industrial manufacturing sector, it is common to use composite components, which are assembled from multiple individual components that are connected to one another. It is a constant aim in the industry, in particular in the automobile industry, to use the lightest weight components possible, which components, due to their shape and connection to adjacent components, meet the appropriate requirements with regard to stability and strength, despite their relatively low weight. The greatest potential for weight reduction/savings is offered by large components, because even a small reduction in wall thickness in large components has a significant effect on the final weight of the components.

To produce large components that are assembled from multiple individual components, which are composed of different materials, it is possible, for example, for components composed of a lightweight metal to be connected to stronger frame components, and for the composite component thus assembled to subsequently be formed into its respective final shape by deep drawing in a heated die. However, a disadvantage of this is that, as the final formed composite component cools, high mechanical stresses are generated in the joint regions because the different individual components typically exhibit different coefficients of thermal expansion.

### SUMMARY

It is an object of the present disclosure to provide a method for producing a lightweight composite component, with which the disadvantages mentioned above in conjunction with the prior art are eliminated. In particular, simple, fast and inexpensive production of the composite component from components composed of different materials may be made possible, without high thermally induced internal stresses being generated in the composite component after it has been formed into its final shape.

In one aspect of the present disclosure, an object hereof may be achieved by a method for producing a composite component, in particular for a vehicle. An embodiment of the method includes providing a first formed component and a second formed component. The first formed component and the second formed component are connected to one another, for example by friction stir welding. In another aspect of the present disclosure, the first component may be of a first specification, and the second component may be of a second specification that differs from the first specification.

### BRIEF DESCRIPTION OF THE DRAWINGS

The present invention is described in detail below with reference to the attached drawing figures, wherein:

FIG. 1 is a schematic side cross-section view of an embodiment of a composite component manufactured by an embodiment of a method and a device of the present disclosure.

FIG. 2a is a schematic perspective view of an embodiment of a composite component manufactured by an embodiment of a method and device of the present disclosure.

FIG. 2b is a perspective detail view of an aspect of the composite component of FIG. 2a.

FIG. 3 is a schematic perspective view of an embodiment of a method and a device for producing a composite component, as disclosed herein.

### DETAILED DESCRIPTION

Disclosed herein is a method for producing a lightweight composite component. In particular, simple, fast and inexpensive production of the composite component from components composed of different materials is made possible, without high thermally induced internal stresses being generated in the composite component after it has been formed into its final shape.

Further disclosed herein is a method for producing a composite component, in particular for a vehicle. In one embodiment of a method of the present disclosure, the method includes providing a first formed component and a second formed component. The first formed component and the second formed component are connected to one another, for example by friction stir welding. In a further embodiment of the present disclosure, the first component may be of a first specification, and the second component may be of a second specification that differs from the first specification.

A method according to the present disclosure has the advantage over the prior art that the two components to be connected to one another are in a formed state before they are connected to one another. It is thus the case that, after the components are connected together, either no forming or only a small amount of forming of the combined composite component is necessary in order to bring the composite component into its final shape. This is made possible by the use of a friction stir welding process to connect the first and second components to each other. With the friction stir welding process, the previously formed/shaped components can be easily connected to one another without the composite component as a whole being subjected to significant heating. A significant advantage of the present disclosure is that, as a result, no high thermally induced internal stresses are generated in the composite component. In particular, in the first and/or second method step, the first and/or second component is provided in each case as a blank that has been cut to size, which may also be formed as a “tailored product”. “Tailored product” should be understood to mean inter alia “tailored blank”, “tailored strip” and “tailored rolled blank”. The first and second specifications each comprise a component specification comprising, for example, component-specific values such as thickness, strength, hardness, formability, ductility or the like. In one embodiment, the composite component comprises in particular a body component for a vehicle, for example at least a part of a bonnet, a tailgate, a vehicle door, an underbody or the like.

In a preferred embodiment of the present disclosure, a first component has a first specification and a second component has a second specification, the second specification defining a smaller thickness, a lower strength, a lower hardness, greater formability and/or higher ductility in relation to the first specification. It is alternatively or additionally conceivable for the first and second specifications to each comprise a material specification. In this case, the first and the second component have different materials or different material compositions. In an alternate embodiment, a steel component is provided as a first component, whereas a light metal component is provided as a second component. In another embodiment, the first component is advantageously always designed to be more stable or more rigid than the second component, whereas the second component is of lower weight than the first component. The first component thus provides the composite component with its structural rigidity, whereas the selection of the second component ensures a reduced overall weight.

In a further preferred embodiment of the present disclosure, a first component in the form of a load-bearing frame component is provided, and a second component in the form of an extensive component is provided. It is preferably the case that, according to an embodiment of a method disclosed herein, the second component is arranged at least partially in the region of an opening of the first component. The first component thus serves as a structurally rigid carrier component which, as carrier component, absorbs loads and, as a frame component, supports the second component, whereas the second component serves primarily for providing the extensive form and/or for closing openings in the carrier component, for example in order to provide a smooth surface. The first component is in particular manufactured from steel. The second component comprises in particular a light metal, composed for example of aluminum, magnesium, titanium or corresponding alloys.

In a further preferred embodiment of the present invention, it is provided that, in a first method step, the first component is produced by forming, in particular deep drawing, and/or wherein, in a second method step, the second component is produced by forming, in particular deep drawing. It is conceivable that, in the first and/or second method step, the first and/or second component is/are initially processed to form semi-finished parts, or that, in the first and/or second method step, the first and/or second component is/are already fully formed into their respective final shapes.

In a further preferred embodiment of the present disclosure, it is provided that, in a third method step, a rotating tool is moved in and/or along a seam between the first and the second component. A welding energy is introduced into the region of the seam in an advantageous manner by the wear-resistant rotating tool. The rotating tool thus heats the region of the seam between the first and the second components to a temperature just below the melting temperature of the material of the components, whereby plasticization of the first and second components occurs in the seam, and mixing of the materials occurs in the joint zone. The rotating tool is preferably moved along the entire seam between the first and the second component, such that the two components are welded to one another along the entire seam. The tool is preferably moved in computer-controlled manner, such that advantageously even relatively complex and individual seam contours can be followed. The input of energy is advantageously restricted to the immediate locality of the seam, such that in particular also after the cooling process, no thermally induced internal stresses are generated between the first and the second component. The friction stir welding process advantageously also makes it possible for the two components to be welded from only one assembly side.

A further subject of the present invention is a device for producing a composite component, in particular by means of the method according to the invention, wherein the device has a first provision means for providing a formed first component and a second provision means for providing a formed second component, wherein furthermore, the device has a friction stir welding device for connecting the first and second components to one another. The device according to the invention has the advantage in relation to the prior art that, by means of the friction stir welding device, even already pre-shaped components can be connected to one another to form a composite component in a simple, fast and inexpensive manner. The device thus permits the production of composite components of reduced weight for vehicle construction, without the risk of high thermally induced internal stresses within the composite component.

In a preferred embodiment of the present invention, it is provided that the device has a positioning device for preliminary positioning the first and second components relative to one another. In this way, precise positioning of the two components relative to one another is advantageously achieved before the friction stir welding process begins and maintained during the friction stir welding process. It is conceivable for a contact pressure to optionally be exerted in the seam between the first and the second component by means of the positioning device during the friction stir welding process.

In a further preferred embodiment of the present invention, it is provided that the friction stir welding device has a rotating tool which is movable in and/or along a seam between the first and the second component. The rotating tool can preferably be moved freely over the first and second components by means of computer control, such that individual seam contours can be precisely followed in a simple manner. The rotating tool is in particular produced from a wear-resistant material. The tool preferably comprises a rotating pin which is fastened to a rotating main body. The main body has an offset which is parallel to the joint surface and which functions as a tool shoulder. It is preferably the case that, during the friction stir welding process, the rotating pin is driven into the seam between the first and the second component, such that the rotating tool shoulder comes into contact with the adjacent surfaces of the two components and a weld seam is generated whose width substantially corresponds to the diameter of the main body.

A further subject of the present invention is a composite component, in particular for a vehicle, produced by means of the method according to the invention, wherein the composite component has a formed first component and a formed second component, wherein the composite component furthermore has a friction-stir-welded connection between the first and the second component, wherein the first component has a first specification, and wherein the second component has a second specification that differs from the first specification. The first component is produced by forming, in particular deep drawing, and/or wherein the second component is produced by forming, in particular deep drawing. The friction-stir-welded connection between the first and the second component advantageously makes it possible for the composite component to be manufactured in a process in which, firstly, the first and/or second component are formed, and the first and second components are only thereafter connected to one another. This prevents high thermally induced internal stresses being generated in the composite component during the production process. The composite component is thus more stable, and less susceptible to undesired deformation, in relation to composite components known from the prior art.

In a further preferred embodiment of the present invention, it is provided that the second component has a second specification which defines a smaller thickness, a lower strength, a lower hardness, greater formability and/or higher ductility in relation to a first specification of the first component, wherein the first component comprises a steel component, preferably in the form of a load-bearing frame component, and the second component comprises a light metal component, preferably in the form of an extensive component. It is advantageously thus possible for a relatively rigid first component, which is more rigid than the second component either by way of its material specification or its component specification, to be used as a structurally rigid carrier and frame component for the relatively lightweight extensive second component. It is conceivable for the first component, as a frame component, to have an opening, wherein the second component, as an extensive component, is arranged at least partially in the region of the opening. In this way, a composite component can be realized which is stable owing to the use of the first component and which is simultaneously lightweight owing to the use of the second component. The composite component comprises a first component in the form of a steel component and a second component in the form of a light metal component, composed for example of aluminum, magnesium, titanium or corresponding alloys.

The composite component comprises in particular a body component of a vehicle, such as for example at least a part of a bonnet, of a tailgate, of a vehicle door or of an underbody.

Further details, features and advantages of the invention are specified in the drawings and in the following description of preferred embodiments on the basis of the drawings. The drawings illustrate merely exemplary embodiments of the invention, which do not restrict the fundamental concepts of the present disclosure.

In the various figures, identical parts are always denoted by the same reference signs and are therefore generally also each referred to or mentioned only once.

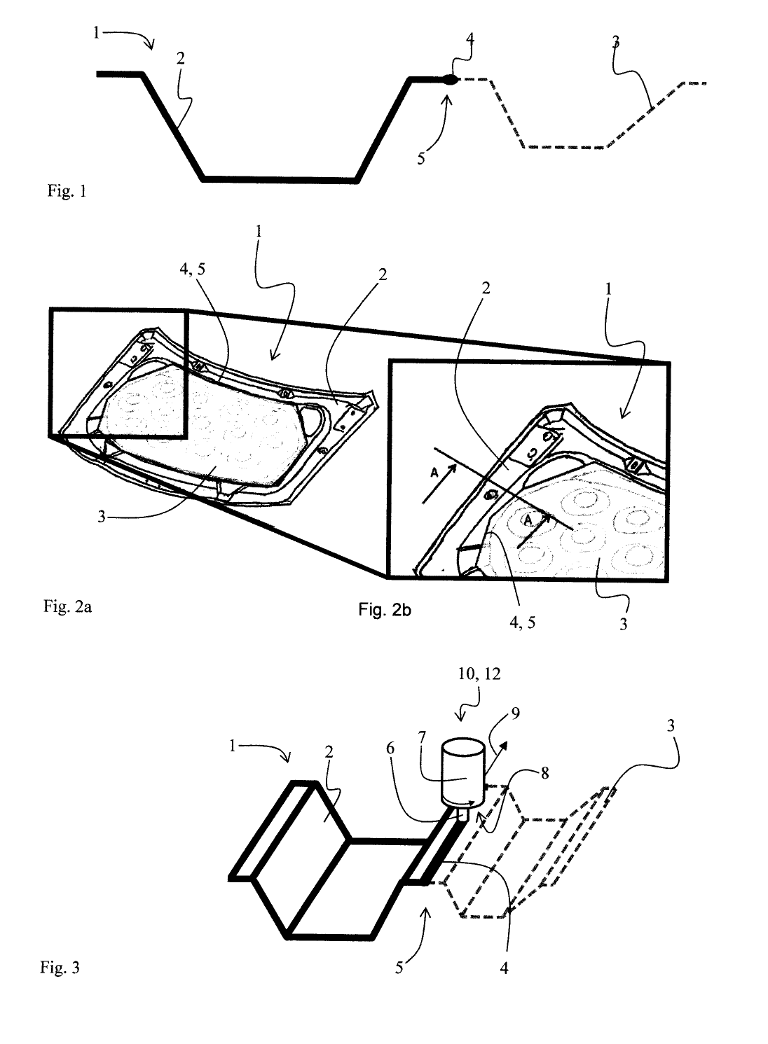

FIG. 1 illustrates a schematic sectional view of a composite component 1 which has been manufactured by means of a method and a device 10 according to an exemplary embodiment of the present invention.

The composite component 1 comprises a first component 2 and a second component 3, which are strongly and metallurgically connected to one another at their seam 5 by way of a friction-stir-welded connection 4. The first and second components 2, 3 each comprise a blank that has been cut to size (which may also be implemented as a “tailored product”), said blanks initially being provided as semi-finished parts and thereafter being formed, for example in the context of a deep drawing process, with the friction-stir-welded connection 4 finally being produced between said semi-finished parts. This method will be explained in detail below on the basis of FIG. 3.

The first component 2 comprises a steel component which serves as a structurally rigid and load-bearing frame component. The second component 3 comprises an extensive component which is manufactured from light metal and which has a smaller thickness, lower rigidity, lower strength, greater formability and/or higher ductility than the first component 2. The second component 3 is preferably manufactured from aluminum or magnesium. The first component 1 serves to provide the composite component 1 with the required strength and structural rigidity, whereas the second component 3 serves primarily to realize the external shape and to provide a large extensive surface. The use of an extensive component manufactured from light metal advantageously has the effect that the overall weight of the composite component 1 can be reduced.

FIG. 1 illustrates a sectional view of the composite component 1, an overall view of which is shown in the subsequent FIG. 2b.

FIGS. 2a and 2b schematically illustrate a perspective overall view and a perspective detail view of the composite component 1 that has been manufactured by means of a method and a device 10 according to an exemplary embodiment of the present invention. The composite component 1 according to the exemplary embodiment comprises, in the present case, a bonnet for a vehicle. Here, the section line A-A whose section is shown in FIG. 1 is indicated in FIG. 2b. The first component 2, as a steel component, functions in this case as a circumferential, load-bearing frame component which has a large-extensive opening 11 in the interior. The second component 3 manufactured from light metal is, as an extensive component, which may include for example a non-structural skin or body panel component, arranged in the interior of the opening 11 and thus defines the surface of the inner panel of a bonnet. The second component 3 preferably comprises magnesium or a magnesium alloy. In this way, a stable and structurally rigid bonnet with corresponding local buckling strength is provided, which can simultaneously be produced in relatively simple and inexpensive manner. The use of preferably soft magnesium in the interior of the frame component furthermore makes it possible to realize effective pedestrian protection. To produce the inner panel of a bonnet, the friction stir welding device is guided along the circumferential seam 5 between the first and the second component 2, 3.

FIG. 3 illustrates a schematic perspective view of the method and of the device 10 for producing the composite component 1 according to the exemplary embodiment of the present invention, as illustrated in FIGS. 1, 2a and 2b. During the production of the composite component 1, in a first method step, the first component 2 is firstly formed into a desired shape by deep drawing. In a separate, second method step, the second component 3 is furthermore likewise brought into a desired shape by deep drawing. The already-formed first component 2 and the already-formed second component 3 are subsequently positioned relative to one another in a third method step, preferably by means of a positioning device (not shown) of the device 10. The first and the second component 2, 3 are in this case arranged in particular in a butt-jointed configuration relative to one another.

The device 10 furthermore has a tool 12 in the form of a friction stir welding device which welds the first and the second component 2, 3 to one another to metallurgically bond them at their seam 5. For this purpose, the friction stir welding device comprises a rapidly rotating pin 6 composed of a wear-resistant material, said pin being connected fixedly to a correspondingly rotating main body 7. In the third method step, the rotating pin 6 is pressed against the seam 5. Owing to the relative movement between the rotating pin 6 and the two stationary components 2, 3, friction heat is generated, whereby the first and the second component 2, 3 are locally heated in the region of the seam 5 to a temperature just below their melting temperature. The pin 6 can then be driven fully into the heated material in the region of the seam 5 until a tool shoulder 8, which is parallel to the surface of the components 2, 3, of the main body 7 comes into contact with the surface. The first and second components 2, 3 are thereby strongly welded to one another in the region of the seam 5. To strongly connect the first and second components 2, 3 to one another throughout their entire transition region, the friction stir welding device is moved along the seam 5 (illustrated by the movement arrow 9). It is conceivable for the friction stir welding device to be movable in computer-controlled manner, such that even complex seam profiles can be followed by the friction stir welding device.

What is claimed is:

1. A method for manufacturing a composite component, comprising:
providing a first formed component having a first specification;
providing a second formed component having a second specification different than the first specification; and
connecting the first formed component to the second formed component by friction stir welding.

2. The method of claim 1, wherein the second specification defines at least one of a smaller thickness, a lower material strength, a lower material hardness, greater formability, or higher material ductility, as compared to the first specification.

3. The method of claim 1, wherein the first component is a steel component, and the second component is a light metal component.

4. The method of claim 1, wherein the first component is a load-bearing frame component, and the second component is an extensive component.

5. The method of claim 1, wherein said first component has an opening defined therein.

6. The method of claim 5, further comprising, prior to said connecting step, arranging the second component at least partially in a region of the opening defined in the first component.

7. The method of claim 1, further comprising, prior to said providing steps, producing the first and second components by deep drawing.

8. The method of claim 1, wherein said connecting step comprises moving a rotating tool along a seam defined between the first and second components.

9. A composite component, comprising:
a formed first component having a first specification;
a formed second component having a second specification different than said first specification, said second component connected to said first component;
a friction-stir-welded joint integrally disposed between and connecting said first and second components to each other.

10. The composite component of claim 9, wherein the second specification defines at least one of a smaller thickness, a lower material strength, a lower material hardness, greater formability, or higher material ductility, as compared to the first specification.

11. The composite component of claim 9, wherein the first component is a steel component, and the second component is a light metal component.

12. The composite component of claim 9, wherein the first component is a load-bearing frame component, and the second component is an extensive component.

13. The composite component of claim 9, wherein said first component has an opening defined therein, and said second component is disposed at least partially in said opening.

14. The composite component of claim 9, wherein the composite component is a body component of a vehicle.
